(19) United States
(12) Patent Application Publication
(10) Pub. No.: US 2024/0093683 A1
(43) Pub. Date: Mar. 21, 2024

(54) FLUID HANDLING SYSTEM

(71) Applicant: Enplas Corporation, Saitama (JP)

(72) Inventor: Nobuya SUNAGA, Saitama (JP)

(73) Assignee: Enplas Corporation, Saitama (JP)

(21) Appl. No.: 18/273,289

(22) PCT Filed: Jan. 22, 2021
(86) PCT No.: PCT/JP2021/002203

§ 371 Date: Jul. 20, 2023

(51) Int. Cl. F04B 43/14

(52) U.S. Cl. CPC F04B 43/14

(57) ABSTRACT

This fluid handling system has: a fluid handling device that includes a flow path and a rotary membrane pump that is connected to the flow path and has a diaphragm for causing fluid to flow along the flow path; and a rotary member that has a protrusion for pressing the diaphragm of the rotary membrane pump. The width of the rotary member protrusion is less than the width of the diaphragm of the rotary membrane pump.

### TECHNICAL FIELD

The present invention relates to a fluid handling system.

### BACKGROUND ART

In recent years, microwell plates, fluid handling devices, and the like are used to analyze, for example, cells, proteins, and nucleic acids. Microwell plates and fluid handling devices are advantageous such that only a small amount of reagents and samples is required for analysis, thus are expected to be used in a variety of applications such as clinical tests, food tests, and environment tests.

For example, Patent Literature (hereinafter, referred to as PTL) 1 discloses a peristaltic pump applicable to fluid handling devices. This peristaltic pump moves fluid by pressing a tube (diaphragm), which forms the pump, with the use of a pressing member as the pressing member rotates.

### CITATION LIST

### Patent Literature

PTL 1

US Patent Application Publication No. 2006/0245964

### SUMMARY OF INVENTION

### Technical Problem

A diaphragm forming a pump is made of a flexible material. A flexible material may be self-adhesive, and when the diaphragm is pressed against a substrate by using a pressing member for causing the diaphragm to function as a pump, the diaphragm may adhere to the substrate. When the diaphragm adheres to the substrate, moving a liquid as intended may become impossible. For example, pressing a pressure member against the diaphragm to generate a positive pressure for sending a liquid may cause adhesion of the diaphragm to the substrate. When the adhesion of the diaphragm is removed after a certain amount of time has passed, an unintended negative pressure may be generated by the removal of the adhesion.

An object of the present invention is to provide a fluid handling system capable of preventing a diaphragm of a pump from adhering to a substrate when the diaphragm is pressed against the substrate with the use of a pressing member.

### Solution to Problem

A fluid handling system of the present invention includes: a fluid handling device including a channel and a membrane pump connected to the channel, where the membrane pump is configured to allow a fluid to flow into or thorough the channel and includes a diaphragm; and a pressing member including a protrusion configured to slide on the diaphragm of the membrane pump. In the fluid handling system, a width of the protrusion of the pressing member is smaller than a width of the diaphragm of the membrane pump.

### Advantageous Effects of Invention

The present invention can provide a fluid handling system capable of preventing a diaphragm of a pump from adhering to a substrate when the diaphragm is pressed against the substrate by using a pressing member.

### BRIEF DESCRIPTION OF DRAWINGS

FIG. 1A is a cross-sectional view illustrating the configuration of a fluid handling system according to an embodiment, and FIG. 1B is a bottom view of a fluid handling device included in the fluid handling system according to the embodiment;

FIG. 2A is a plan view of the fluid handling device; FIG. 2B is a bottom view of the fluid handling device, and FIG. 2C is a bottom view of a substrate of the fluid handling device;

FIGS. 3A and 3B are partially enlarged cross-sectional views each illustrating the fluid handling device according to the embodiment;

FIG. 4A is a plan view of a second rotary member of the fluid handling system according to the embodiment, FIG. 4B is a cross-sectional view thereof, and FIG. 4C illustrates the configuration of a second protrusion; and

FIG. 5A illustrates the operation of a fluid handling system of a comparative example, and FIGS. 5B and 5C illustrate the operation of the fluid handling system according to the embodiment.

### DESCRIPTION OF EMBODIMENTS

Hereinafter, an embodiment of the present invention will be described in detail with reference to the accompanying drawings.

### Configuration of Fluid Handling System

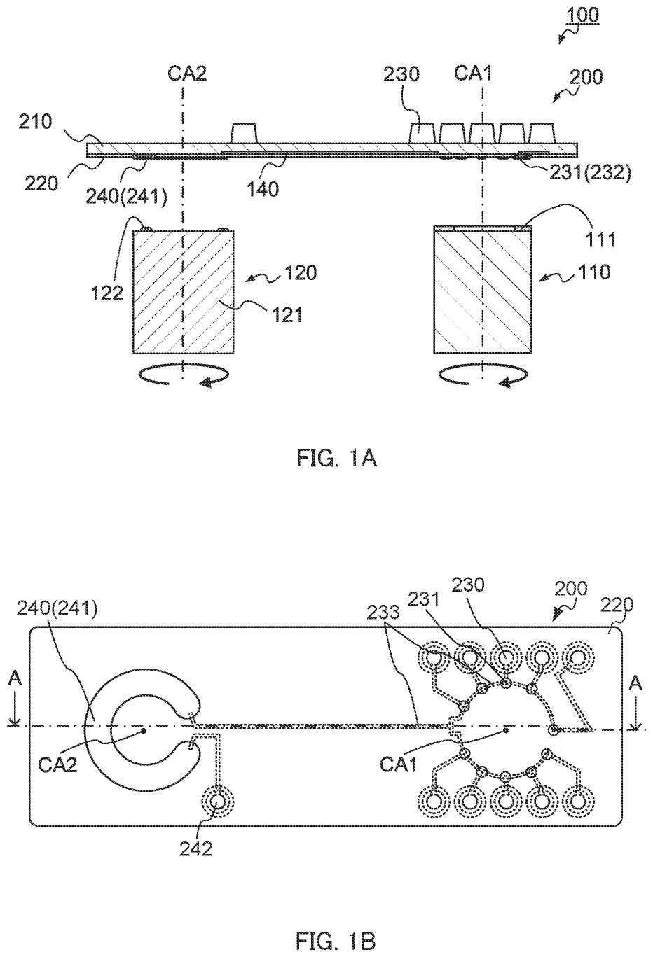

FIG. 1A is a cross-sectional view illustrating the configuration of fluid handling system 100 according to the present embodiment. FIG. 1B is a bottom view of fluid handling device 200 included in fluid handling system 100 according to the present embodiment. In FIG. 1B, internal components such as channels are indicated by dashed lines for explanation. The cross-section of fluid handling system 100 in FIG. 1A is a cross-sectional view taken along line A-A in FIG. 1B.

As illustrated in FIG. 1A, fluid handling system 100 includes fluid handling device 200, first rotary member 110 for pressing valves 231 of rotary membrane valves of fluid handling device 200, and second rotary member 120 for pressing rotary membrane pump 240 of fluid handling device 200. First rotary member 110 is rotated about first central axis CA1 by an external drive mechanism (not illustrated). Second rotary member 120 is rotated about second central axis CA2 by an external drive mechanism (not illustrated). Fluid handling device 200 includes substrate 210 and film 220, and film 220 is placed so as to contact with first rotary member 110 and second rotary member 120. FIG. 1A illustrates the components separately for easy understanding of the configuration of fluid handling system 100.

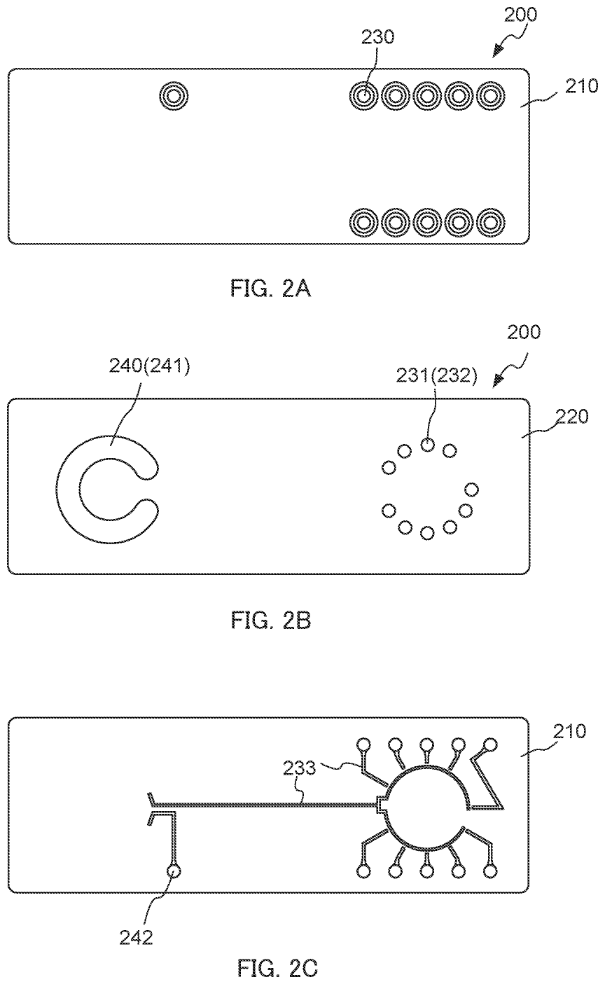

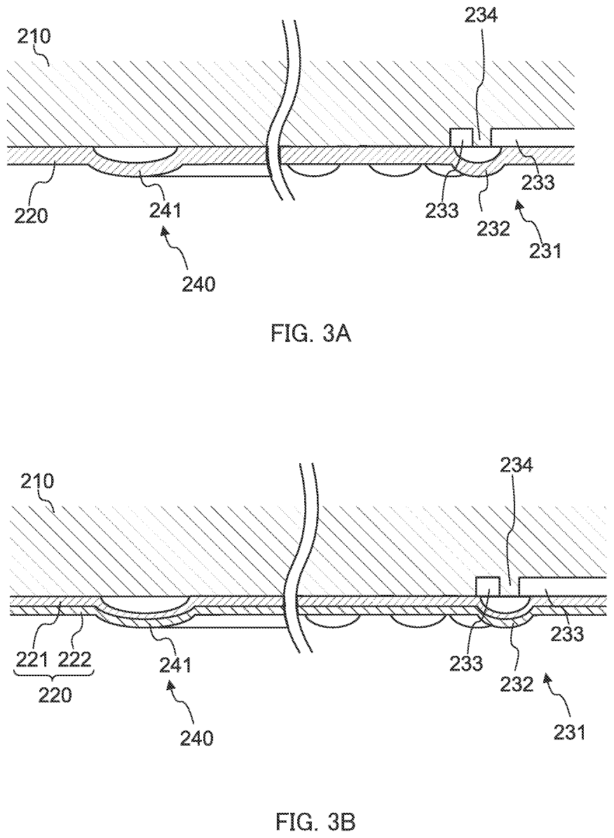

FIGS. 2A to 2C each illustrate the configuration of fluid handling device 200. FIG. 2A is a plan view of fluid handling device 200 (a plan view of substrate 210). FIG. 2B is a bottom view of fluid handling device 200 (bottom view of film 220). FIG. 2C is a bottom view of substrate 210 (bottom view of fluid handling device 200 with film 220 removed). FIGS. 3A and 3B are partially enlarged cross-sectional views each illustrating valve 231 and rotary membrane pump 240.

As described above, fluid handling device 200 includes substrate 210 and film 220 (see FIG. 1A). In substrate 210, grooves to serve as channels and through holes to serve as introduction ports or discharge ports are formed. Film 220 is joined to one of the surfaces of substrate 210 so as to block the openings of the recesses and through holes formed in substrate 210. Some regions of film 220 function as diaphragms. The grooves of substrate 210 blocked by film 220 serve as channels for fluids, such as reagents, liquid samples, washing liquids, gases, and powders, to flow therethrough.

The thickness of substrate 210 is not limited. For example, the thickness of substrate 210 is 1 mm or more and 10 mm or less. Substrate 210 may be in the form of a film with a thickness of less than 1 mm. In addition, the material for substrate 210 is not limited. For example, the material for substrate 210 may be appropriately selected from known resins and glass. The material for substrate 210 may be elastic. Examples of the materials for substrate 210 include polyethylene terephthalate, polycarbonate, polymethyl methacrylate, polyvinyl chloride, polypropylene, polyether, polyethylene, polystyrene, cyclo-olefine resins, silicone resins, and elastomers.

The thickness of film 220 is not limited as long as the film can function as a diaphragm. For example, the thickness of film 220 is 30 μm or more and 300 μm or less. The material for film 220 is not limited either as long as the film can function as a diaphragm. For example, the material for film 220 may be appropriately selected from known resins. In addition, even a self-adhesive material can be used for film 220 because adhesion of the film to substrate 210 is prevented in the present embodiment. As will be described below, film 220 may include two or more layers. When film 220 includes of two or more layers, the film closest to substrate 210 may be made of a self-adhesive material.

Examples of the materials for film 220 include polyethylene terephthalate, polycarbonate, polymethyl methacrylate, polyvinyl chloride, polypropylene, polyether, polyethylene, polystyrene, cyclo-olefine resins, silicone resins, and elastomers. Examples of the elastomers include olefin elastomers and cyclo-olefin elastomers (cyclo-olefin elastic bodies). Film 220 is joined to substrate 210 by, for example, heat welding, laser welding, or using an adhesive. The material for film 220 may be the same as or different from the material for substrate 210. The same or similar materials are more likely to become self-adhesive; thus the present embodiment is particularly useful when the materials of film 220 and substrate 210 are the same as or similar to each other.

As illustrated in FIGS. 1A, 1B, and 2A, fluid handling device 200 includes wells 230, valves 231, channels 233, and rotary membrane pump 240. A fluid introduced into well 230 is controlled by opening and closing of valve 231 and sent to channel 233 by driving rotary membrane pump 240. These members will be described below.

Well 230 is a bottomed recess. The number of wells 230 is not limited, and is appropriately set according to the application. In the present embodiment, fluid handling device 200 includes a plurality of wells 230, as illustrated in FIGS. 1A and 1B.

In the present embodiment, each of these wells (recesses) is composed of a through hole formed in substrate 210 and film 220 blocking one of the openings of the through hole. The shape and size of each recesses are not limited, and can be appropriately set according to the application. Each recess has, for example, a substantially cylindrical shape. The width of each recess is, for example, approximately 2 mm.

Valve 231 is a membrane valve (diaphragm valve) configured to control the flow of liquid in channel 233. In the present embodiment, valves 231 are rotary membrane valves whose opening and closing are controlled by the rotation of first rotary member 110. More specifically, valve 231 is controlled to open and close by the rotation of first rotary member 110. In the present embodiment, the plurality of valves 231 are disposed on the circumference of a first circle whose center is central axis CAL In addition, valve 231 is disposed between well 230 and channel 233 (see FIG. 1B).

As illustrated in FIG. 3A, valve 231 includes partition wall 234 and diaphragm 232. Valve 231 is closed by diaphragm 232 coming into contact with partition wall 234.

In the present embodiment, partition wall 234 of valve 231 is disposed between channels 233 (see FIGS. 1B and 3A). Diaphragm 232 of valve 231 is disposed to face partition wall 234 (see FIG. 3A).

Partition wall 234 of valve 231 functions as a valve seat of a membrane valve (diaphragm valve) for opening and closing the area between channels 233. The shape and height of partition wall 234 are not limited as long as the above functions can be exhibited. Partition wall 234 has, for example, a quadrangular prism shape. The height of each partition wall 234 is, for example, the same as the depth of corresponding channel 233.

Diaphragm 232 of valve 231 is part of flexible film 220 and has a substantially spherical crown shape (dome shape) (see FIGS. 1A and 3A). Film 220 is disposed on substrate 210 in such a way that each diaphragm 232 is not in contact with and faces corresponding partition wall 234.

Diaphragm 232 of valve 231 bends toward corresponding partition wall 234 when the diaphragm is pressed by first protrusion 111 of first rotary member 110 (see FIG. 1A). These diaphragms 232 thus function as valve bodies for the diaphragm valves. For example, when first protrusion 111 is not pressing diaphragm 232 of valve 231, well 230 and channel 233 communicate with each other through the gap between diaphragm 232 and partition wall 234. On the other hand, when first protrusion 111 is pressing diaphragm 232 so that diaphragm 232 contacts partition wall 234, well 230 and channel 233 do not communicate with each other.

Diaphragm 232 of valve 231 may be formed of film 220 including a single layer as illustrated in FIG. 3A or film 220 including two or more layers as illustrated in FIG. 3B. In the embodiment illustrated in FIG. 3B, film 220 includes first film 221 and second film 222. When film 220 includes two or more layers in this manner, it is possible to prevent abrasion of the inner film, which may be caused by sliding. Specifically, when film 220 includes two or more layers, the outer film (second film 222) can prevent abrasion of the inner film (first film 221) to be caused by sliding.

Channel 233 is a channel through which fluid can move. In one end thereof, channel 233 is connected to wells 230, and in the other end thereof, channel 233 is connected to rotary membrane pump 240.

In the present embodiment, each of channels 233 is composed of a groove formed in substrate 210 and film 220 blocking the opening of the groove. The cross-sectional area and cross-sectional shape of each channel are not limited. Herein, a “cross section of a channel” means a cross section—orthogonal to the direction in which a liquid flows—of a channel. The cross-sectional shape of each channel is, for example, a substantially rectangular shape with a side length (width and depth) of about several tens of μm. The cross-sectional area of each channel may or may not be constant in the direction of fluid flow. In the present embodiment, the cross-sectional area of each channel is constant.

As illustrated in FIGS. 1A and 1B, rotary membrane pump 240 is a space which has a substantially arc shape (“C” shape) in plan view and is formed between substrate 210 and film 220. One end of rotary membrane pump 240 is connected to channel 233, and the other end of rotary membrane pump 240 is connected to vent hole 242. In the present embodiment, rotary membrane pump 240 is composed of the bottom surface of substrate 210 and diaphragm 241 facing the bottom surface while being separated from the bottom surface (see FIG. 3A). Diaphragm 241 is a portion of flexible film 220. Diaphragm 241 is disposed on the circumference of one circle whose center is central axis CA2. The shape of a cross section—orthogonal to the circumference—of diaphragm 241 is not limited, and is arc-shaped in the present embodiment.

Diaphragm 241 of rotary membrane pump 240 bends and contacts substrate 210 when the diaphragm is pressed by second protrusion 122 of second rotary member 120. For example, when second protrusion 122 slides on and presses diaphragm 241 from the connection part of rotary membrane pump 240 with channel 233 toward the connection part of rotary membrane pump 240 with vent hole 242 (counterclockwise in FIG. 1B), the pressure inside channel 233 becomes negative, and a fluid inside channel 233 moves toward rotary membrane pump 240. On the other hand, when second protrusion 122 slides on and presses diaphragm 241 from the connection part with vent hole 241 toward the connection part with channel 233 (clockwise in FIG. 1B), the pressure inside channel 233 becomes positive, and a fluid inside rotary membrane pump 240 moves toward channel 233.

Diaphragm 241 of rotary membrane pump 240 may be film 220 including a single layer as illustrated in FIG. 3A or film 220 including two or more layers as illustrated in FIG. 3B. In the embodiment illustrated in FIG. 3B, film 220 includes first film 221 and second film 222. Therefore, when film 220 includes two or more layers, the outer film (second film 222) can prevent abrasion of the inner film (first film 221), which may be caused by sliding.

Vent hole 242 is a bottomed recess for introducing fluid (for example, air) into rotary membrane pump 240 or discharging fluid (for example, air) from rotary membrane pump 240 when second protrusion 122 of second rotary member 120 slides on and presses diaphragm 241 of rotary membrane pump 240. In the present embodiment, vent hole 242 is composed of a through hole formed in substrate 210 and film 220 blocking one of the openings of the through hole. The shape and size of vent hole 242 are not limited, and can be appropriately set as necessary. Vent hole 242 has, for example, a substantially cylindrical shape. The width of vent hole 242 is, for example, approximately 2 mm.

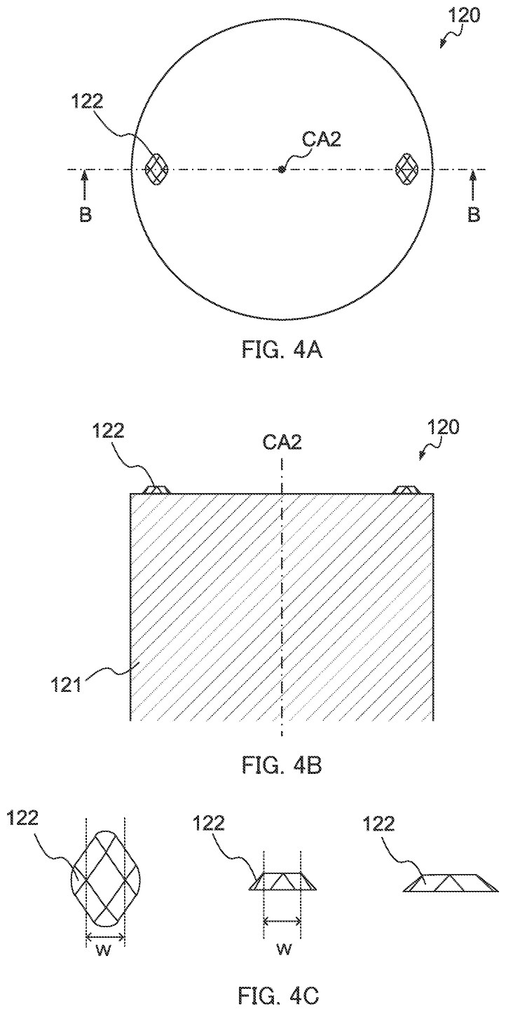

FIG. 4A is a plan view of second rotary member 120, and FIG. 4B is a cross-sectional view taken along line B-B of FIG. 4A. FIG. 4C illustrates, from the left, a plan view, a front view, and a side view of the second protrusion.

Second rotary member 120 is a member including a protrusion for pressing diaphragm 241 of rotary membrane pump 240. Specifically, the second rotary member is a member including second main body 121 and a second protrusion.

Second main body 121 has a cylindrical shape and includes second protrusion 122 disposed on its top surface. Second main body 121 is rotatable about second central axis CA2. Second main body 121 is rotated by an external drive mechanism (not illustrated).

Second protrusion 122 is a protrusion for pressing diaphragm 241 of rotary membrane pump 240. The width of second protrusion 122 of second rotary member 120 is smaller than that of diaphragm 241 of rotary membrane pump 240. This configuration can prevent the diaphragm from adhering to the substrate when the diaphragm is pressed against the substrate by the protrusion. Herein, the “width of second protrusion 122” is defined as the length of a portion—contacting diaphragm 241—of second protrusion 122. The length is in the direction perpendicular to the direction of forward movement (herein also referred to as “forward movement direction”) of second protrusion 122 (the rotation direction of second rotary member 120). Similarly, the “width of diaphragm 241” is defined as the length of diaphragm 241 in the direction perpendicular to the forward movement direction of second protrusion 122 (the rotation direction of second rotary member 120).

More specifically, the ratio of the width of second protrusion 122 of second rotary member 120 to the width of diaphragm 241 of rotary membrane pump 240 is preferably 0.3 to 0.7:1.0 from the viewpoint of preventing adhesion of diaphragm 241.

In addition, for preventing the adhesion of the diaphragm to the substrate, second protrusion 122 of second rotary member 120 in plan view preferably has a shape that tapers (i.e., becomes thinner toward the front side) in the forward movement direction of the second protrusion as illustrated in FIG. 4A and the left diagram of FIG. 4C. Herein, the forward movement direction is directed to both clockwise direction and counterclockwise direction about central axis CA2. As a result, the second protrusion preferably has a substantially quadrangular shape (substantially diamond shape) that tapers in these two forward movement directions. When there are a long diagonal line and a short diagonal line in this substantially quadrangular shape, the second protrusion is preferably disposed in such a way that the long diagonal line is along the forward movement directions.

As illustrated in the middle diagram of FIG. 4C, the second protrusion in front view preferably has a shape that tapers (i.e., becomes thinner) toward diaphragm 241. In addition, as illustrated in the right diagram of FIG. 4C, the second protrusion preferably has a shape that tapers toward diaphragm 241 in side view. Herein, “front view” is defined as a view seen from a direction along the forward movement direction of the second protrusion, and “side view” is defined as a view seen from a direction perpendicular to the forward movement direction.

When second protrusion 122 has a shape that tapers in the forward movement direction, the aforementioned “width of second protrusion 122” means the widest width of the second protrusion. Further, when second protrusion 122 has a shape that tapers toward diaphragm 241, the width of second protrusion 122 means the widest width W of the upper surface as illustrated in the left and middle diagrams of FIG. 4C.

In addition, in the present embodiment, second protrusion 122 substantially has a shape of a truncated quadrangular pyramid. More specifically, in the present embodiment, second protrusion 122 has a shape of a truncated quadrangular pyramid whose bottom surface is diamond shaped, and four corners of the truncated quadrangular pyramid on the bottom surface side are rounded. Rounding the corners can reduce abrasion of diaphragm 241.

The above embodiment describes fluid handling system 100 including rotary membrane pump 240 as a membrane pump and second rotary member 120 as a pressing member; however, embodiments of the invention are not limited thereto. In the embodiments of the present invention, any configuration is possible as long as the membrane pump includes a diaphragm, and the pressing member includes a protrusion configured to slide on the diaphragm of the membrane pump.

Examples of membrane pumps other than rotary membrane pump 240 include linear membrane pumps. Examples of corresponding pressing members include pressing members that are configured to move linearly back and forth.

Operation of Fluid Handling System

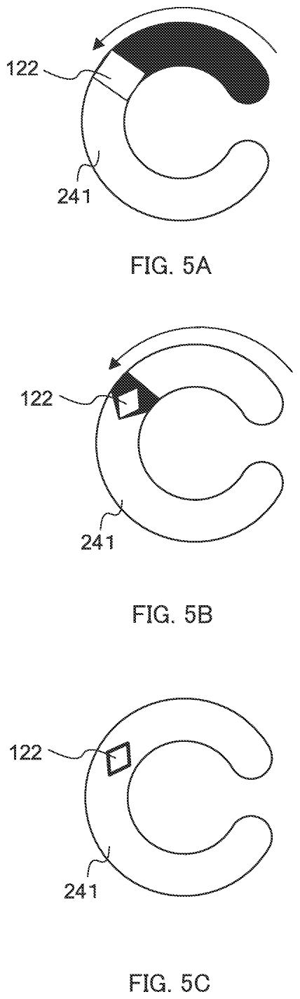

In the following, the operation of a fluid handling system will be described with reference to FIGS. 5A to 5C. In FIGS. 5A to 5C, a portion—in contact with the substrate upon pressing from second protrusion 122 of second rotary member 120—of diaphragm 241 is filled in black. In the present embodiment, substrate 210 and film 220 are made of self-adhesive materials. In the present embodiment, substrate 210 is made of cyclo-olefin resin, film 220 includes two layers, first film 221 (inner film) is made of olefin elastomer, and second film 222 (outer film) is made of polypropylene.

FIG. 5A illustrates the case where second protrusion 122 of second rotary member perform pressing diaphragm 241 in the counterclockwise direction as indicated by the arrow in a fluid handling system of a comparative example. FIG. 5B illustrates a case where second protrusion 122 of fluid handling system 100 according to the present embodiment presses in a similar manner.

As illustrated in FIG. 5A, the width of second protrusion 122 is equal to or greater than that of diaphragm 241 in the fluid handling system of the comparative example; thus, the portion where diaphragm 241 continues to adhere to the substrate is increased upon pressing. Then, after a certain amount of time has passed, the adhesion is removed due to the flexibility of diaphragm 241. An unintended negative pressure may be generated by the removal of the adhesion.

On the other hand, the width of second protrusion 122 is smaller than that of diaphragm 241 in fluid handling system 100 of the present embodiment as illustrated in FIG. 5B. Therefore, when diaphragm 241 adheres to the substrate, the adhesion is quickly removed thereafter, and the portion where diaphragm 241 adheres is reduced.

FIG. 5B illustrates a state in which the first rotary member is still rotating. While the first rotary member is rotating, diaphragm 241 and the substrate are in contact with each other over the entire width of diaphragm 241 behind the diaphragm in the forward movement direction even when the width of second protrusion 122 is smaller than that of diaphragm 241. This is because, during the rotation, diaphragm 241 is pulled by second protrusion 122 and comes into contact with the substrate behind the diaphragm in the forward movement direction. As a result, even when the width of second protrusion 122 is smaller than that of diaphragm 241, the pump function can be exhibited.

FIG. 5C illustrates a state in which second protrusion 122 of second rotary member 120 stops rotating from the state of FIG. 5B in fluid handling system 100 of the present embodiment. The width of second protrusion 122 is smaller than that of the diaphragm; thus, when second rotary member 120 stops rotating, the adhesion is quickly removed, and only a portion of diaphragm 241 immediately below and around second protrusion 122 is in contact with the substrate.

Effects

The width of second protrusion 122 is smaller than that of diaphragm 241 in fluid handling system 100 of the present embodiment; thus, it is possible to prevent diaphragm 241 from adhering to the substrate. This configuration makes it easier to control a fluid as intended.

### INDUSTRIAL APPLICABILITY

Fluid handling systems of the present invention are particularly advantageous, for example, in a variety of applications such as clinical, food, and environmental testing.

### REFERENCE SIGNS LIST

100 Fluid handling system
110 First rotary member
111 First protrusion
120 Second rotary member
121 Second main body
122 Second protrusion
200 Fluid handling device
210 Substrate
220 Film
221 First film
222 Second film
230 Well
231 Valve
232, 241 Diaphragm
233 Channel
234 Partition wall
240 Rotary membrane pump
242 Vent hole
CA1, CA2 Central axis

1. A fluid handling system, comprising:
a fluid handling device including a channel and a membrane pump connected to the channel, wherein the membrane pump is configured to allow a fluid to flow into or thorough the channel and includes a diaphragm; and
a pressing member including a protrusion configured to slide on the diaphragm of the membrane pump,
wherein
a width of the protrusion of the pressing member is smaller than a width of the diaphragm of the membrane pump.

2. The fluid handling system according to claim 1, wherein a ratio of the width of the protrusion to the width of the diaphragm is 0.3 to 0.7:1.0.

3. The fluid handling system according to claim 1, wherein the protrusion in plan view has a shape that tapers in a forward movement direction of the protrusion.

4. The fluid handling system according to claim 1, wherein the protrusion in front view has a shape that tapers toward the diaphragm.

5. The fluid handling system according to claim 1, wherein the protrusion has a shape of a truncated quadrangular pyramid in which a corner on a bottom surface side of the truncated quadrangular pyramid is rounded.

6. The fluid handling system according to claim 1, wherein the membrane pump is a rotary membrane pump, and the pressing member is a rotary member.
